(19) United States
(12) Patent Application Publication
(10) Pub. No.: US 2016/0222652 A1
(43) Pub. Date: Aug. 4, 2016

(54) INSULATING GLASS WITH LOAD-BEARING PROPERTIES

(71) Applicant: Glas Trösch Holding AG, Buochs (CH)

(72) Inventor: Bruno KASSNEL-HENNEBERG, Diedorf (DE)

(73) Assignee: Glas Trösch Holding AG, Buochs (CH)

(21) Appl. No.: 15/009,236

(22) Filed: Jan. 28, 2016

(30) Foreign Application Priority Data
Jan. 29, 2015 (CH) 00104/15

(51) Int. Cl. E04B 2/92; E06B 3/66; E06B 3/56; E06B 3/64; E06B 3/02; E06B 3/54

(52) U.S. Cl. CPC E04B 2/92; E06B 3/025; E06B 3/5409; E06B 3/56; E06B 3/645; E06B 3/6612; E06B 3/6621

(57) ABSTRACT

The present application relates to an insulating glass (1) having at least two glass panes (2, 3) spaced apart from one another. The insulating glass (1) comprises at least one marginal join arranged between the glass panes (2, 3) in the region (8, 9, 10, 11) of edges (4, 5, 6, 7) of said glass panes (2, 3) , said marginal join consisting of a spacer (12) and also at least one adhesive. The marginal join comprises a first adhesive at least in the region (8, 9) of two mutually opposite edges (4, 5), said adhesive having a rigidity in the cured state of at least 50 N/mm², preferably of at least 100 N/mm².

### TECHNICAL FIELD

The invention relates to an insulating glass which can be used, in particular in façade construction, as a load-bearing structure.

### PRIOR ART

A multiple-pane insulating glass is a component for windows which comprises at least two glass panes. A pane intermediate space is located between the glass panes and is filled with air or a gas, in particular a noble gas. In order to mechanically hold the glass panes together at a distance, spacers are used.

Known spacers are, for example, profiles made of aluminum, high-grade steel or plastic, which are connected to the glass panes on both sides by means of a layer of a sealant, in particular polyisobutylene. The sealant additionally acts as an adhesive, which adhesively bonds the glass panes to the spacer. The intermediate space between the edge of the glass panes and the spacer is usually filled with a polymer, for example a polyurethane, in order to achieve further sealing and adhesive bonding of the glass panes.

In order that an insulating glass has adequate stability for resisting loads, which arise, for example, through wind, use is presently made of a frame made of plastic, aluminum or wood, this frame framing the circumference of the insulating glass. The insulating glass is reinforced by the frame. If the insulating glass is moreover intended to perform a load-bearing function, for example in façade construction, in which for example the insulating glass is used without being supported by a frame system, this is only possible to a limited extent. In such a case, the glass panes have to have a correspondingly rigid form in order to be able to resist the loads.

### SUMMARY OF THE INVENTION

It is an object of the invention to provide an insulating glass appropriate to the technical field mentioned in the introduction in which it is possible to dispense with a frame system and which can be used in façade construction as a load-bearing structure.

The achievement of the object is defined by the features of claim 1. According to the invention, the insulating glass comprises at least two glass panes spaced apart from one another. A marginal join is arranged between the glass panes at least in the region of edges of said glass panes. The marginal join consists of a spacer and also at least one adhesive, wherein the marginal join comprises a first adhesive at least in the region of two mutually opposite edges, said adhesive having a rigidity in the cured state of at least 50 N/mm², preferably of at least 100 N/mm².

The use of an adhesive having such a high rigidity over a loading duration which is typical in the case of a wind load which, pursuant to the standard SIA 261 of 2014, arises with an effective duration of 3 to 10 seconds produces a relatively rigid insulating glass having a high resistance. It is therefore possible for an insulating glass of this type to perform a load-bearing function, in particular in façade construction, it being necessary for the insulating glass pane to be supported only at the two edges in the region of which the first adhesive is arranged. The two other edges in this case do not have to be supported by a conventional façade substructure (pillar). In this case, it is possible to dispense with a frame structure entirely, or it is possible for said frame structure to be reduced to minimal dimensions.

Spacers are known from the prior art. They can be manufactured from any desired material, such as for example aluminum. In the case of the insulating glass according to the invention, a spacer made of a polymer is preferably used, as a result of which the thermal conductivity can be reduced, this having a positive effect on the thermal insulation of an insulating glass according to the invention. The spacer can be configured as a hollow profile or as a solid profile.

The adhesive preferably has constant mechanical properties, in particular said rigidity in a temperature range of at least −20° C. to at least +80° C. As a result, the structural dimensions of the insulating glass do not vary too greatly depending on the temperature. This provides an efficient applicability of the insulating glass with respect to wind loads and also climatic loads in a wide temperature range.

A sealant, in particular polyisobutyl, is preferably arranged between a respective glass pane and the spacer, as is known from the prior art.

The distance between the at least two glass panes is preferably between 8 mm and 20 mm. The first adhesive preferably fills the intermediate space between the at least two glass panes completely in terms of height, that is to say that the thickness of the first adhesive corresponds to the distance between the at least two glass panes.

35

The first adhesive preferably has a short-term stability with respect to erosion by wind loads of at least 5 N/mm², preferably of at least 10 N/mm². Short-term stability is understood to mean the resistance of the adhesive which the latter has during wind loading of between 3 seconds and 10 seconds.

The first adhesive is preferably applied in the region of the at least two mutually opposite edges to a width of 20 mm to 200 mm, in particular of 20 mm to 120 mm, from the edge in the direction of the center of the glass panes.

The variation in the width of the first adhesive in this region makes it possible to optimally adapt the rigidity and the resistance of the insulating glass according to the expected loading, while simultaneously using thin glass panes. It is thereby possible to save material, and this reduces the production costs for an insulating glass pane according to the invention.

Depending on the mechanical demands on the insulating glass, the width of the first adhesive applied can be adapted. The mechanical demands are determined in particular by the climatic conditions and also the expected maximum wind loads at the site at which the insulating glass is used.

It is preferable that the at least two glass panes are rectangular, the longer of the four edges having a length of at least 2 meters. The solution according to the invention also makes it possible to produce large insulating glasses, since these have a high stability by virtue of the relatively high strength compared to insulating glasses according to the prior art.

The marginal join preferably comprises the first adhesive in the region of those opposing edges in which the insulating glass is supported during the intended use thereof. By virtue of this arrangement of the first adhesive in these regions, it is possible to achieve targeted stiffening of the marginal join in the region of those edges which are exposed to the greatest loading.

The marginal join preferably comprises at least one second adhesive in the region of the further edges of the glass panes, the second adhesive having a lower rigidity than the first adhesive.

The use of an adhesive having a lower rigidity makes it possible to reduce the loading on the marginal join, in particular as a result of climatic loading, along the edges at which the insulating glass is not supported.

The at least one second adhesive is preferably applied to a smaller width in the region of the further edges than the first adhesive in the region of the two opposing edges.

Particularly if the first adhesive is applied in the region of those edges which are exposed to the greatest loading, the width of the applied adhesive can be reduced in the region of the further edges. It is thereby possible both to save material costs and also to improve the visual appearance of the insulating glass pane.

It is preferable that the width of the adhesive in the region of each edge is adapted according to the expected forces, which are to be expected on account of the planned site of use, the prevailing climatic conditions and also the size of the insulating glass pane.

At least one respective anchoring element is preferably inserted in the first adhesive in the region of the at least two mutually opposite edges.

It is thereby possible for the insulating glass according to the invention to be connected to further structures, such as for example steel girders. Since the first adhesive has a high tensile strength, it is possible with the insulating glass according to the invention to fasten anchoring elements directly and without the aid of further components on the insulating glass itself.

A film consisting of a polymer is preferably stretched between the at least two glass panes and parallel thereto, the film being spaced apart from the glass panes in each case by way of at least one spacer.

In this way, an additional thermal insulation layer can be introduced into the insulating glass without the insulating glass experiencing a significant increase in weight—as would be the case if a further glass pane were to be arranged in the insulating glass. In this case, the film is spaced apart from the glass panes in each case via a spacer.

It is preferable that the outermost glass panes of the at least two glass panes consist of a glass laminate. It is thereby possible for the resistance of the insulating glass to be additionally increased.

It is a further object of the invention to provide a method for producing an insulating glass, in particular an insulating glass according to the above description. The method according to the invention comprises, as the first step, the provision of a first glass pane, and in a second step at least one spacer is arranged circumferentially in the region of the edges of the first glass pane at a distance. This is followed by the application of a first adhesive, which has a rigidity in the cured state of at least 50 N/mm², between at least two mutually opposite edges of the first glass pane and the associated spacer. A second glass pane is positioned on the at least one spacer before or after the application of the first adhesive.

Depending on the desired number of glass panes in the insulating glass, it is possible to arrange further layers consisting of a marginal join comprising a spacer and first adhesive and also a glass pane on the insulating glass. It is thereby possible, for example, to also produce a triple insulating glass, in addition to the described double insulating glass, with the method according to the invention.

The two mutually opposite edges are preferably those edges at which the insulating glass is supported during intended use.

Further advantageous embodiments and combinations of features of the invention arise from the following detailed description and the entirety of the patent claims.

### BRIEF DESCRIPTION OF THE DRAWINGS

The drawings used to explain the exemplary embodiment show:

FIG. 1 a schematic illustration of an insulating glass according to the invention;

FIGS. 2a-2c sections of insulating glasses according to the invention in cross section;

FIG. 3 a section of a further embodiment of an insulating glass according to the invention in cross section;

FIG. 4 a further embodiment of an insulating glass according to the invention in cross section.

In principle, identical parts are denoted by identical reference signs in the figures.

### WAYS OF CARRYING OUT THE INVENTION

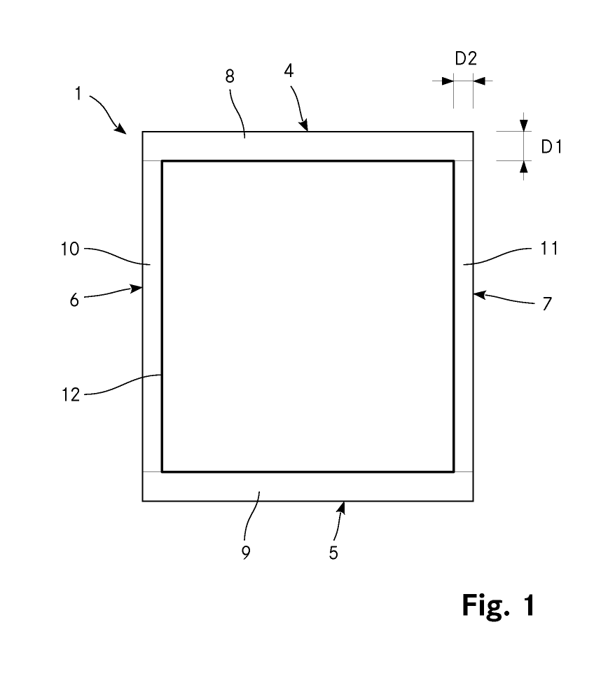

FIG. 1 shows a schematic illustration of an insulating glass 1 according to the invention. The insulating glass 1 comprises two glass panes, which are held spaced apart from one another by a spacer 12. The spacer 12 is arranged at a first distance D1 in a first region 8 and a second region 9, which adjoin a first edge 4 and respectively an edge 5 lying opposite the first edge 4. In a third region 10 and a fourth region 11, the spacer 12 is arranged at a second distance D2 from a third edge 6 and respectively from a fourth edge 7. The first distance D1 is greater than the second distance D2.

A first adhesive having a rigidity of at least 50 N/mm² in the cured state is introduced between the two glass panes in the first region 8 and in the second region 9 between the first edge 4 or the second edge 5 and the spacer 12. A second adhesive having a lower rigidity than the first adhesive in the cured state is introduced in the third region 10 and in the fourth region 11 between the third edge 6 or the fourth edge 7 and the spacer 12. The spacer 12 and also the first adhesive or the second adhesive form what is termed the marginal join of the insulating glass 1.

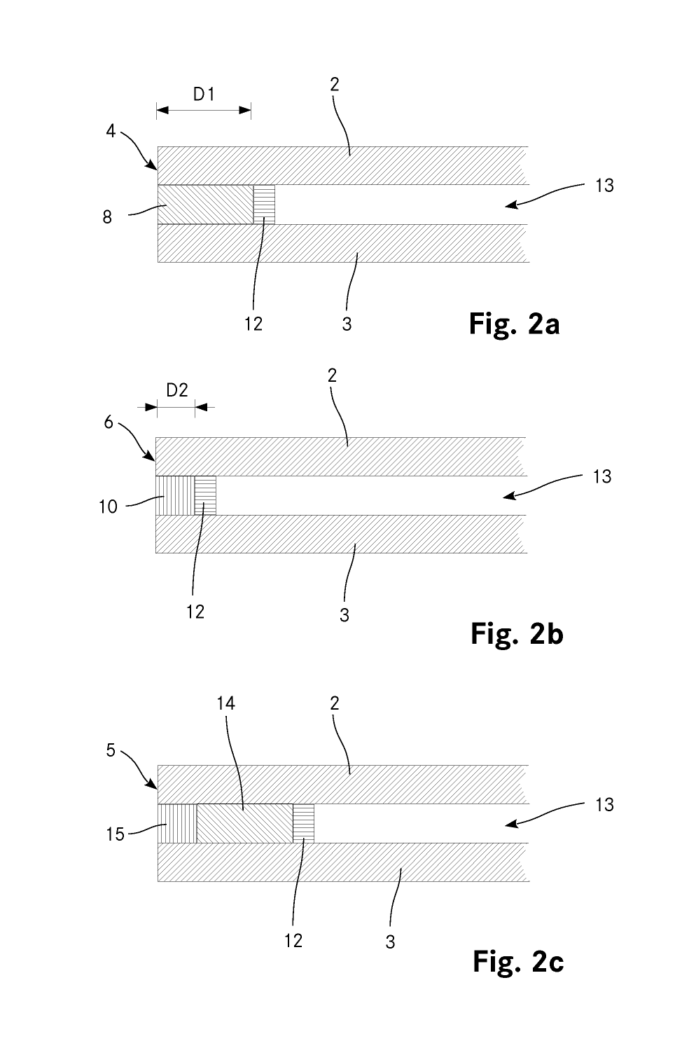

FIGS. 2a to 2c show sections of insulating glasses according to the invention in cross section. FIG. 2a shows a cross section through the first region 8. The spacer 12 is arranged between the first glass pane 2 and the second glass pane 3 at the first distance D1 from the first edge 4. An intermediate space 13, which can be filled for example with an inert gas, is formed in the inner region of the insulating glass as a result of the spacer 12. For reasons of illustration, the spacer 12 is shown in the form of a quadrangle. It ought to be clear to a person skilled in the art, however, that the spacer 12 can be present in any suitable shape. Various shapes and configurations of spacers are known from the prior art. Furthermore, an adhesive and sealant such as polyisobutyl is preferably arranged between the spacer 12 and the glass panes 2, 3, as is known from the prior art. The first adhesive is introduced in the intermediate space between the two glass panes 2, 3 and also the first edge 4 and the spacer 12. A person skilled in the art will understand that the cross section through the second region 9 which adjoins the second edge 5 lying opposite the first edge 4 is identical to the cross section shown here.

FIG. 2b shows a cross section through the third region 10. The spacer 12 is arranged between the two glass panes 2, 3 spaced apart from the third edge 6 at a second distance D2. The second adhesive is introduced in the intermediate space between the two glass panes 2, 3 and also the third edge 4 and the spacer 12. A person skilled in the art will understand that the cross section through the fourth region 11 is identical to the cross section shown here.

FIG. 2c shows a further embodiment of an insulating glass 1 according to the present invention. In this case, the first adhesive is introduced between the two glass panes 2, 3 between the first edge 5 and the spacer 12 in a first partial region 14. A further adhesive or a sealant is introduced in a second partial region 15. It is thereby possible for the properties of a marginal join to be varied depending on the site of use and the intended use of the insulating glass.

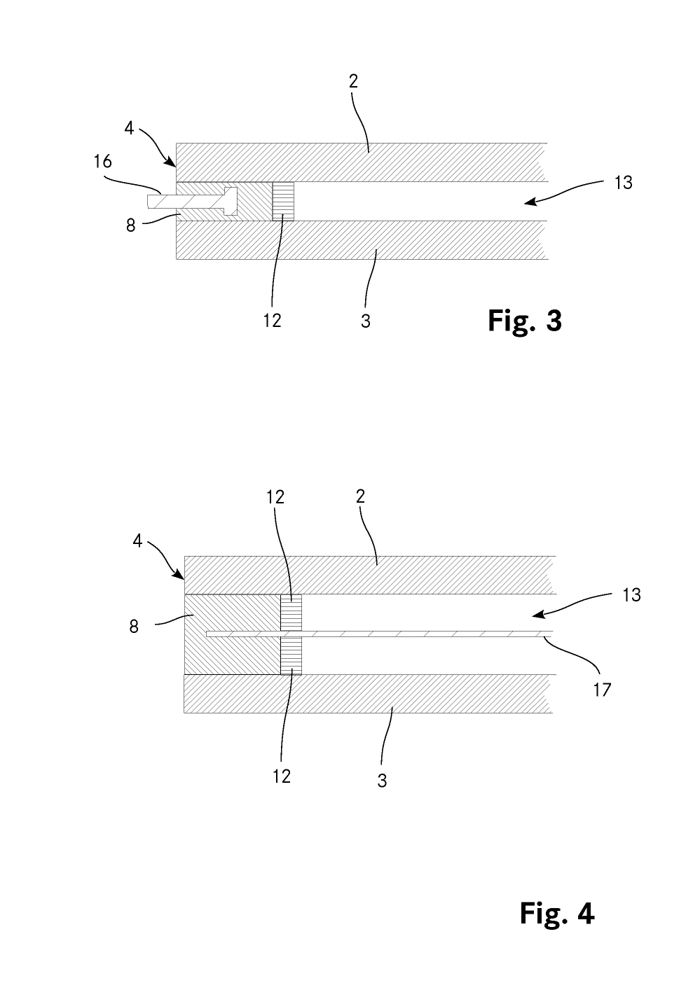

FIG. 3 shows a section of a further embodiment of an insulating glass 1 in cross section. In the case of this embodiment, an anchoring element 16 is inserted in the second adhesive in the first region 8. The insulating glass 1 can be connected, for example, to further elements via the anchoring element 16.

FIG. 4 shows a further embodiment of an insulating glass 1. In the case of this embodiment, a film 17 is arranged between the two glass panes 2, 3 and is spaced apart from the glass panes 2, 3 by a respective spacer 12. In this case, the film 12 is embedded in the first adhesive. The film 17 forms an additional heat barrier between the two glass panes 2, 3, and this increases the thermal insulation of the insulating glass 1.

1. Insulating glass having at least two glass panes spaced apart from one another, said insulating glass comprising at least one marginal join arranged between the glass panes in the region of edges of said glass panes, said marginal join consisting of a spacer and also at least one adhesive, wherein the marginal join comprises a first adhesive at least in the region of two mutually opposite edges, said adhesive having a rigidity in the cured state of at least 50 N/mm², preferably of at least 100 N/mm².

2. Insulating glass according to claim 1, the adhesive has a short-term stability with respect to erosion by wind loads of at least 5 N/mm², preferably of at least 10 N/mm².

3. Insulating glass according to claim 1, wherein the first adhesive is applied in the region of the at least two mutually opposite edges to a width of 20 mm to 200 mm, from the edge in the direction of the center of the glass panes.

4. Insulating glass according to claim 1, wherein the marginal join comprises the first adhesive in the region of those opposing edges in which the insulating glass is supported during the intended use thereof.

5. Insulating glass according to claim 1, wherein the marginal join comprises at least one second adhesive in the regions of the further edges of the glass panes, the second adhesive having a lower rigidity in the cured state than the first adhesive.

6. Insulating glass according to claim 1, wherein the at least one second adhesive is applied to a smaller width in the regions of the further edges than the first adhesive in the regions of the two opposing edges.

7. Insulating glass according to claim 1, wherein at least one respective anchoring element is inserted in the first adhesive in the regions of the at least two mutually opposite edges.

8. Insulating glass according to claim 1, wherein a film consisting of a polymer is stretched between the at least two glass panes and parallel thereto, wherein the film is spaced apart from each of the glass panes by way of at least one spacer.

9. Insulating glass according to claim 1, wherein the outermost glass panes of the at least two glass panes consist of a glass laminate.

10. Method for producing an insulating glass, in particular according to claim 1, said method comprising the following steps:
a) providing a first glass pane;
b) arranging at least one spacer circumferentially in the regions of the edges of the first glass pane at a distance from the edges;
c) applying a first adhesive, which has a rigidity in the cured state of at least 50 N/mm², between at least two mutually opposite edges of the first glass pane and the spacer,
wherein a second glass pane is positioned on the at least one spacer before or after the application of the first adhesive.

11. Insulating glass according to claim 1, wherein the first adhesive is applied in the region of the least two mutually opposite edges to a width of 80 mm to 120 mm from the edge in the direction of the center of the glass panes.
